(19) United States
(12) Patent Application Publication
(10) Pub. No.: US 2008/0024479 A1
(43) Pub. Date: Jan. 31, 2008

(54) ORGANIC ELECTRO-LUMINESCENT DISPLAY DEVICE AND MANUFACTURING METHOD THEREOF

(76) Inventors: Kwang Chul Jung, Seongnam-si (KR); Joon Chul Goh, Seoul (KR); Beohm Rock Choi, Seoul (KR); Chong Chul Chai, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 11/829,021

(22) Filed: Jul. 26, 2007

(30) Foreign Application Priority Data
Jul. 31, 2006 (KR) 10-2006-0072283

(51) Int. Cl. G06F 3/038; G09G 3/30

(52) U.S. Cl. 345/211; 345/77

(57) ABSTRACT

An organic electro-luminescent display device capable of protecting an active layer region from unintended exposure to light is provided. An organic electro-luminescent display device includes a gate line; a data line extending substantially perpendicularly to the gate line; a power supply line supplying a power signal, a switching thin film transistor connected to the gate line and to the data line, the switching thin film transistor having a first channel region; a driving thin film transistor connected to the switching thin film transistor and to the power supply line, the driving thin film transistor having a second channel region; an organic electro-luminescent cell connected to the driving thin film transistor, and a light absorption layer formed on at least one of the first and second channel regions, the light absorption layer being formed of at least one color layer.

### RELATED APPLICATION

This application claims priority to Korean Patent Application No. 2006-72283 filed on Jul. 31, 2006 under 35 U.S.C. §119, the content of which is herein incorporated by reference in its entirety.

### BACKGROUND

The present invention relates to an electro-luminescent device and, in particular, to an organic electro-luminescent display device capable of protecting an active layer of a thin film transistor from unintended exposure to light.

An active matrix organic electro-luminescent display device displays an image through a pixel matrix comprised of pixels each consisting of red (R), green (G), and blue (B) sub-pixels. Each sub-pixel is independently implemented with an organic electro-luminescent (“OEL”) cell and a cell driver. The OEL cell includes an anode connected to the cell driver, a cathode that is grounded, and an organic layer interposed between the anode and the cathode. The cell driver driving the OEL cell includes at least two thin film transistors and a storage capacitor, connected between a gate line providing a scan signal, a data line providing a data signal, and a power line providing a power signal.

In the above structured OEL display device, sometimes light generated at the organic layer and/or reflected by the cathode may reach one or more of the two thin film transistors of the cell driver. In this case, channel regions, which are controlled by the thin film transistors, are improperly activated, thereby causing problems such as current leakage, crosstalk, current distortion, etc.

In a conventional method for manufacturing the OEL display device, organic layers are formed through a screen mask process within a pixel hole provided by a bank dielectric layer. That is, a first organic layer having a red light emission layer is formed inside a pixel hole located at a red sub-pixel by a deposition process using a mask. After the first organic layer is formed, a second organic layer having a green light emission layer is formed inside a pixel hole located at a green sub-pixel by a deposition process using a mask. Similarly, a third organic layer having a blue light emission layer is formed inside a pixel hole located at a blue sub-pixel by a deposition process using a mask.

A problem with this conventional method is that it requires an almost perfect alignment of the mask. If there is a misalignment of the screen mask, the organic layers for the respective colors cause color interferences. This problem becomes especially serious in a high-definition OEL display device.

### BRIEF SUMMARY

The present invention is an organic electro-luminescent display device capable of preventing active layers of thin film transistors from being exposed to unintended light and a method of manufacturing the same.

In one aspect, the present invention is an organic electro-luminescent display device that includes a gate line, a data line extending substantially perpendicularly to the gate line, a power supply line supplying a power signal, a switching thin film transistor connected to the gate line and to the data line and having a first channel region, a driving thin film transistor connected to the switching thin film transistor and to the power supply line and having a second channel region, an organic electro-luminescent cell connected to the driving thin film transistor, and a light absorption layer formed on at least one of the first and second channel regions, the light absorption layer being formed of at least one color layer.

In another aspect, the present invention is a method of manufacturing an organic electro-luminescent display device. The method includes forming a switching thin film transistor connected to the a gate line and to a data line on an dielectric substrate and forming a driving thin film transistor connected to the switching thin film transistor and to a power supply line on the dielectric substrate. The switching thin film transistor and the driving thin film transistor have first and second channel regions, respectively. The method entails forming a light absorption layer formed of at least one color layer on at least one of the first and the second channel regions, and forming an organic electro-luminescent cell connected to the driving thin film transistor.

In some embodiments, forming the electro-luminescence cell includes forming an anode connected to the driving thin film transistor, forming an organic layer generating white light on the anode, and forming a cathode facing the anode on the organic layer.

In some embodiments, the method further includes forming a red color filter, a green color filter, and a blue color filter overlapping the anode in corresponding sub-pixel regions while forming the light absorption layer.

In some embodiment, forming the light absorption layer includes forming at least one color layer formed from the substantially same material as at least one of the red, green, and blue color filters.

In some embodiments, the light absorption layer includes a plurality of color layers emitting different colors.

### BRIEF DESCRIPTION OF THE DRAWINGS

The above and other features and advantages of the present invention will become readily apparent by reference to the following detailed description when considered in conjunction with the accompanying drawings, wherein:

FIG. 1 is a plan view illustrating a sub-pixel of an organic electro-luminescent (OEL) display device according to an exemplary embodiment of the present invention;

FIG. 2 is a cross sectional view of the sub-pixel taken along the line I-I′ of FIG. 1;

FIGS. 3A to 3C are cross sectional views of light absorption layers formed with two different color layers according to another exemplary embodiment of the present invention;

FIG. 4 is a plan view of a unit pixel composed of sub-pixels implemented as in FIGS. 1 and 2;

FIG. 5 is a plan view of a unit pixel of an OEL display device according to another exemplary embodiment of the present invention;

FIG. 6A is a plan view illustrating an exemplary method of forming a gate metal pattern of a sub-pixel of FIGS. 1 and 2;

FIG. 6B is a cross sectional view taken along the line I-I′ of FIG. 6A;

FIG. 7A is a plan view illustrating an exemplary method of forming a semiconductor pattern of the sub-pixel of FIGS. 1 and 2;

FIG. 7B is a cross sectional view taken along the line I-I′ of FIG. 7A;

FIG. 8A is a plan view illustrating an exemplary method of forming a source/drain metal pattern of the sub-pixel of FIGS. 1 and 2;

FIG. 8B is a cross sectional view taken along the line I-I′ of FIG. 8A;

FIG. 9A is a plan view illustrating an exemplary method of forming a light absorption layer of the sub-pixel of FIGS. 1 and 2;

FIG. 9B is a cross sectional view taken along the line I-I′ of FIG. 9A;

FIG. 10A is a plan view illustrating an exemplary method of forming a planarization layer of a sub-pixel of FIGS. 1 and 2;

FIG. 10B is a cross sectional view taken along the line I-I′ of FIG. 10A;

FIG. 11A is a plan view illustrating an exemplary method of forming the transparent conductive pattern for the sub-pixel of FIGS. 1 and 2;

FIG. 11B is a cross sectional view taken along the line I-I′ of FIG. 11A;

FIG. 12A is a plan view illustrating an exemplary method of forming the pixel hole for the sub-pixel of FIGS. 1 and 2;

FIG. 12B is a cross sectional view taken along the line I-I′ of FIG. 12A;

FIG. 13A is a plan view illustrating an exemplary method of forming the organic layer and the cathode for the sub-pixel of FIGS. 1 and 2; and

FIG. 13B is a cross sectional view taken along the line I-I′ of FIG. 13B.

### DETAILED DESCRIPTION

Exemplary embodiments of the present invention are described with reference to the accompanying drawings in detail. The same reference numbers will be used throughout the drawings to refer to the same or like parts. Detailed descriptions of well-known functions and structures incorporated herein may be omitted to avoid obscuring the subject matter of the present invention.

The present invention may be embodied in many different forms. the invention is shown in drawings and described herein in detail with reference to specific embodiments, with the understanding that the present disclosure is an exemplification of the principles of the invention and is not intended to limit the invention to the specific embodiments illustrated.

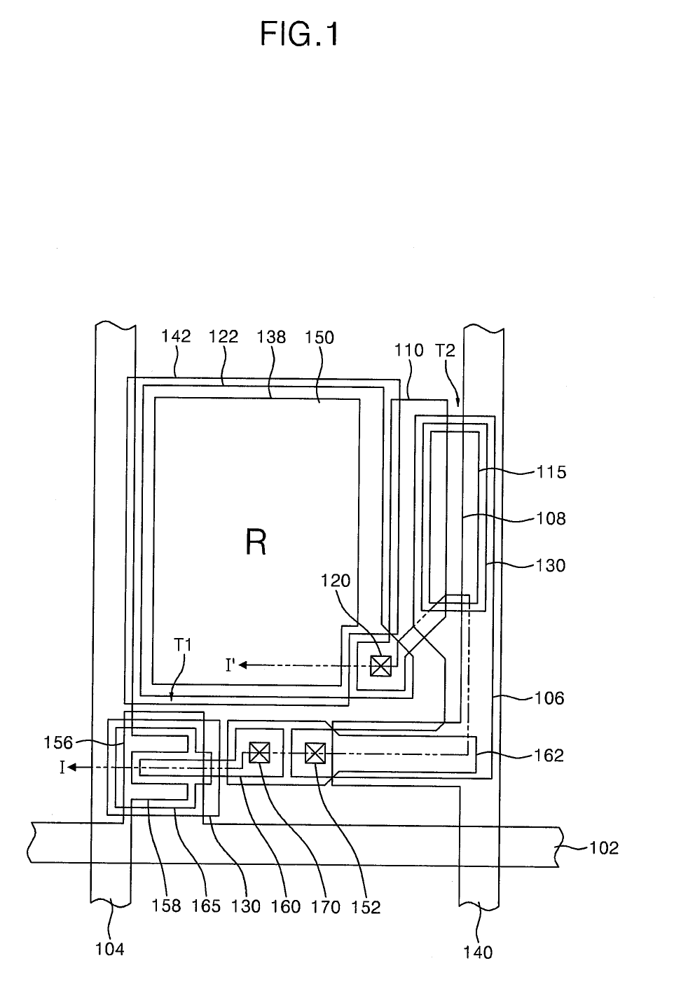

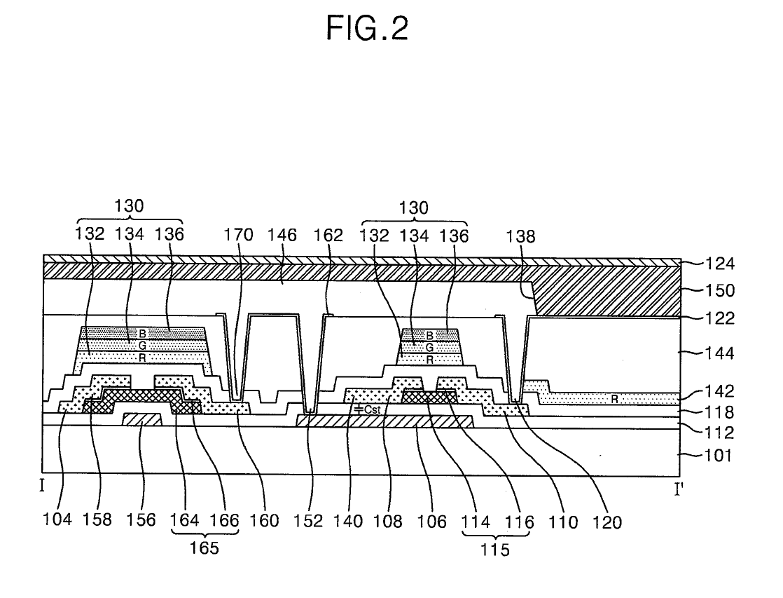

FIG. 1 is a plan view illustrating a sub-pixel of an organic electro-luminescence (“OEL”) display device according to an exemplary embodiment of the present invention, and FIG. 2 is a cross sectional view of the sub-pixel taken along the line I-I′ of FIG. 1.

Referring to FIGS. 1 and 2, a sub-pixel of an OEL display device includes a gate line 102 formed on a dielectric substrate 101, a data line 104 crossing the gate line 102, and a power supply line 140 crossing the gate line 102 arranged parallel to the data line 104. The three lines together define a sub-pixel region. The sub-pixel of an OEL display device further includes a switching thin film transistor T1 connected to the gate line 102 and to the data line 104, a driving thin film transistor T2 connected between the switching thin film transistor T1, the power supply line 140, and an anode 122 of an OEL cell, a storage capacitor Cst connected between the power line 140 and a drain electrode 160 of the switching thin film transistor T1, the OEL cell connected to the driving thin film transistor T2, a color filter 142 overlapping the OEL cell, and a light absorption layer 130 overlapping the switching transistor T1 and the driving transistor T2.

The gate line 102 provides a scan signal to the switching thin film transistor T1, the data line 104 provides a data signal to the switching thin film transistor T1, and the power supply line 140 provides a power signal to the driving thin film transistor T2.

When a scan pulse is provided on the gate line 102, the switching thin film transistor T1 is turned ON so as to provide the data signal from the data line 104 to the capacitor Cst and a second gate electrode 106 of the driving thin film transistor T2. The switching thin film transistor T1 includes a first gate electrode 156 connected to the gate line 102, a first source electrode 158 connected to the data line 104, a first drain electrode 160 facing the first source electrode 158 and connected to the second gate electrode 106 of the driving thin film transistor T2 and to the storage capacitor Cst, and a first semiconductor pattern 165 forming a channel region between the first source electrode 158 and the first drain electrode 160. The first semiconductor pattern 165 includes a first active layer region 164 overlapping the first gate electrode 156 with a gate dielectric layer 112 disposed therebetween. An ohmic contact layer region 166 is formed on parts of the first active layer region 164 except for the part above the channel region for providing ohmic contact between the first source and drain electrodes 158 and 160.

The driving thin film transistor T2 adjusts the luminance of the OEL cell by controlling the current provided to the OEL cell through the power supply line 140 in response to the data signal provided from the second gate electrode 106. The driving thin film transistor T2 includes the second gate electrode 106 connected to the first drain electrode 160 of the switching thin film transistor T1 through a connection electrode 162, a second source electrode 108 connected to the power supply line 140, a second drain electrode 110 facing the second source electrode 108 and connected to the anode 122 of the OEL cell, and a second semiconductor pattern 115 forming a channel region between the second source and drain electrodes 108 and 110. The connection electrode 162 is formed from the substantially same material as the anode 122 on a planarization layer 144. The connection electrode 162 connects the first drain electrode 160 of the switching thin film transistor T1 that is at the base of a first contact hole 170 to the second gate electrode 106 of the driving thin film transistor T2 that is at the base of a second contact hole 152.

The first contact hole 170 extends to the first drain electrode 160 through a protection layer 118 and the planarization layer 144, and the second contact hole 152 exposes the second gate electrode 106 by penetrating the gate dielectric layer 112, the protection layer 118, and the planarization layer 144.

The second semiconductor pattern 115 includes a second active layer region 114 overlapping the second gate electrode 106 with the gate dielectric layer 112 disposed therebetween, and a second ohmic contact layer region 116 formed on parts of the second active layer region 114 except for the part above the channel region for providing ohmic contact between the second source and drain electrodes 108 and 110.

The storage capacitor Cst is formed such that the power supply line 140 overlaps the second gate electrode 106 of the driving thin film transistor T2 with the gate dielectric layer 112 interposed therebetween. The driving thin film transistor T2 provides a predetermined current to the OEL cell using the voltage charged in the storage capacitor Cst until it receives a data signal of the next frame. This is true even when the switching thin film transistor T1 is turned OFF, and thus a constant light emission of the OEL cell can be maintained.

The OEL cell includes the anode 122 made of a transparent conductive material formed on the planarization layer 144, an organic layer 150 having a light emission layer formed on the anode 122 at the base of a pixel hole 138 and on a bank dielectric layer 146, and a cathode 124 formed on the organic layer 150. The organic layer 150 includes a hole injection layer, a hole transport layer, a light emission layer, an electron transport layer, and an electron injection layer deposited on the anode and the bank dielectric layer 146. The light emission layer may be implemented in the form of triple color layers emitting red (R), green (G), and blue (B) colors, respectively. The light emission layer may also be implemented in the form of dual color layers emitting complementary colors or in the form of a single color layer emitting a white color. The light emission layer in the organic layer 150 generates light according to the amount of current supplied to the anode 122 and emits white light to the color filter 142 via the anode 122.

The organic layer 150 of an OEL display device according to an exemplary embodiment of the present invention is implemented as a white organic layer so that any color interference problem caused by screen mask misalignment is avoided. The cathode 124 and the anode 122 sandwich the organic layer 150. The anode 122 is formed on the planarization layer 144 and overlaps the color filter 142 in each sub-pixel. The anode 122 is connected to the second drain electrode 110 of the driving thin film transistor T2 at the base of a third contact hole 120. The third contact hole 120 extends through the protection layer 118 and the planarization layer 144.

The color filter 142 is formed on the protection layer 118 to overlap the organic layer 150 which emits white light, so that the color filter 142 generates the red, green, and blue light using the white light from the organic layer 150. The red, green, blue light generated from the color filter 142 is emitted outside through the dielectric substrate 101.

The light absorption layer 130 is configured to cover at least one of the channel regions of the switching thin film transistor T1 and the driving thin film transistor T2. The light absorption layer 130 weakens or absorbs the white light that is generated by the organic layer 150 or reflected by the cathode 124, preventing the white light from reaching the switching thin film transistor T1 and the driving thin film transistor T2. The light absorption layer 130 may be formed as a single color layer or multiple color layers as shown in FIG. 2.

The light absorption layer 130 that is formed as a single color layer partially absorbs the white light before the white light reaches the switching thin film transistor T1 and the driving thin film transistor T2. The white light weakened by the light absorption layer 130 reaches the switching thin film transistor T1 and the driving thin film transistor T2.

Referring to FIG. 2, the light absorption layer 130 is implemented by sequentially depositing three color layers, i.e. a first color layer 132 emitting a red (R) color, a second color layer 134 emitting a green (G) color, and a third color layer 136 emitting a blue (B) color.

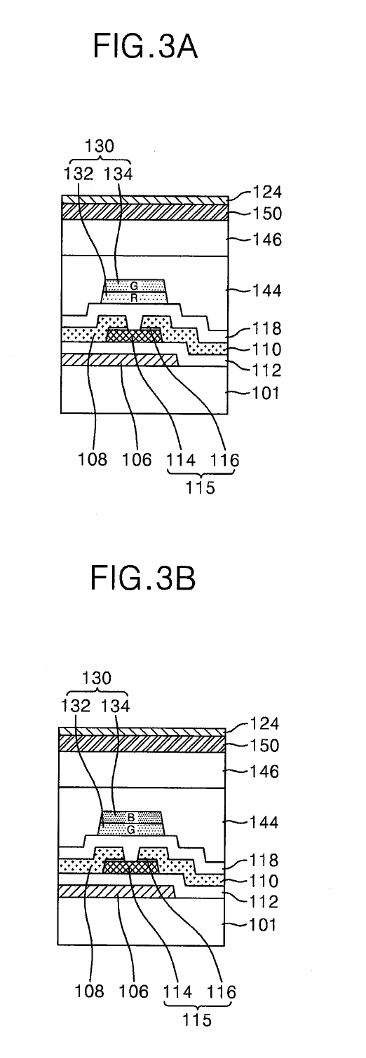

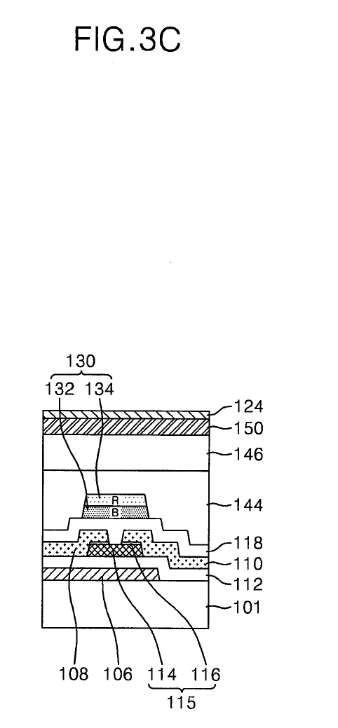

FIGS. 3A to 3C are cross-sectional views of light absorption layers formed with two different color layers according to another exemplary embodiment of the present invention.

In FIG. 3A, the light absorption layer 130 is formed by depositing a red color layer as the first color layer 132 and a green or blue color layer as the second color layer 134. In FIG. 3B, the light absorption layer 130 is formed by depositing a green color layer as the first color layer 132 and a blue or red color layer as the second color layer 134. In FIG. 3C, the light absorption layer 130 is formed by depositing a blue color layer as the first color layer 132 and a red or green color layer as the second color layer 134. The light absorption layer 130 formed with at least two different color layers absorbs the white light emitted from the organic layer before it reaches the switching thin film transistor T1 and the driving thin film transistor T2.

By preventing the switching thin film transistor T1 and the driving thin film transistor T2 from being exposed to white light, it is possible to protect the channel regions of the switching thin film transistor T1 and the driving thin film transistor T2 from being improperly activated. Since the light absorption layer 130 serves as a black matrix that prevents light leakage and absorbs incident light, it is possible to improve productivity and to reduce the manufacturing cost by omitting a separate processes for forming the black matrix. The red, green, and blue color layers are formed with the substantially same material by using the substantially same mask process as the red, green, and blue color filters 142, respectively.

The planarization layer 144 is formed by depositing an organic dielectric material on the color filter 142 and on the light absorption layer 130. The planarization layer 144 is formed so as to provide a plane surface by compensating for the stepped portion of the color filter 142 and of the light absorption layer 130.

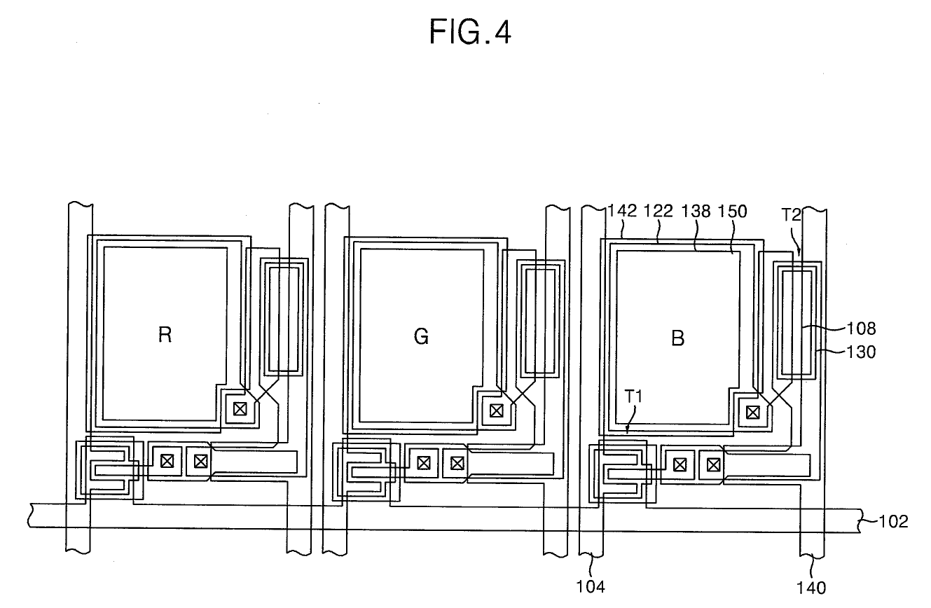

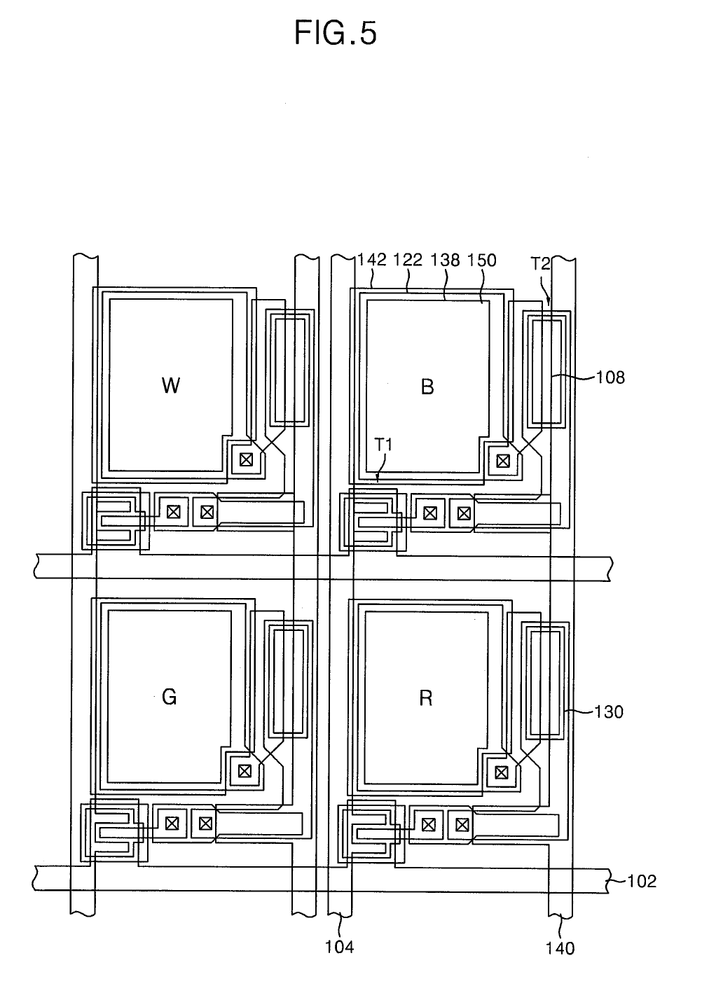

FIG. 4 is a plan view illustrating a unit pixel composed of the sub-pixels in FIGS. 1 and 2. As shown, “unit pixel” includes a red (R) sub-pixel, a green (G) sub-pixel, and a blue (B) sub-pixel in this embodiment.

FIG. 5 is a plan view of a unit pixel of an OEL display device according to another exemplary embodiment of the present invention. In FIG. 5, a unit pixel includes a white (W) sub-pixel in addition to the red (R) green (G), and blue (B) sub-pixels in order to improve luminance. When the white color is displayed by activating all the red, green, blue, and white color sub-pixels, power consumption increases. In order to minimize the power consumption, only the white color sub-pixel (and not the red, green and blue sub-pixels) is selectively activated when white color is displayed.

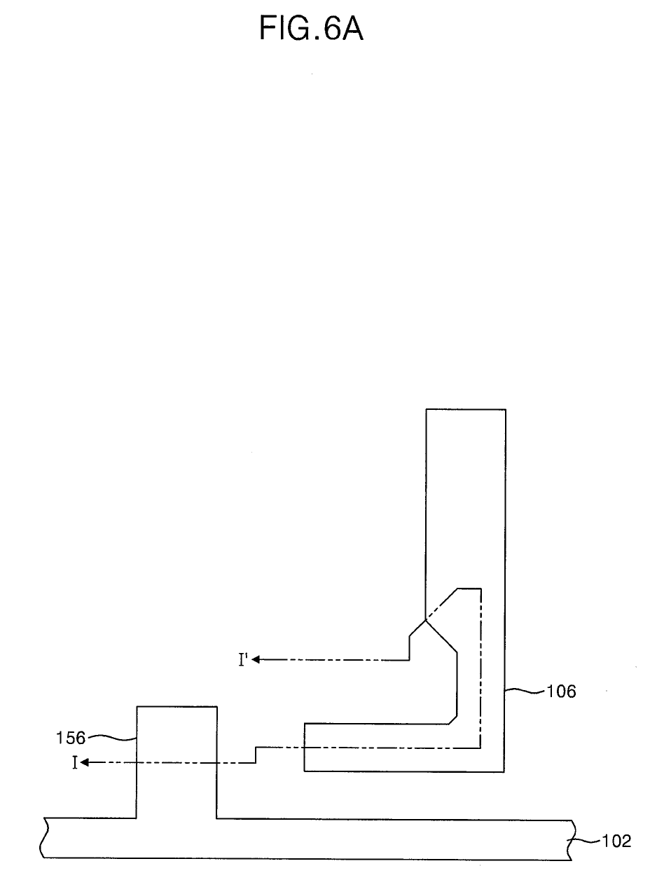

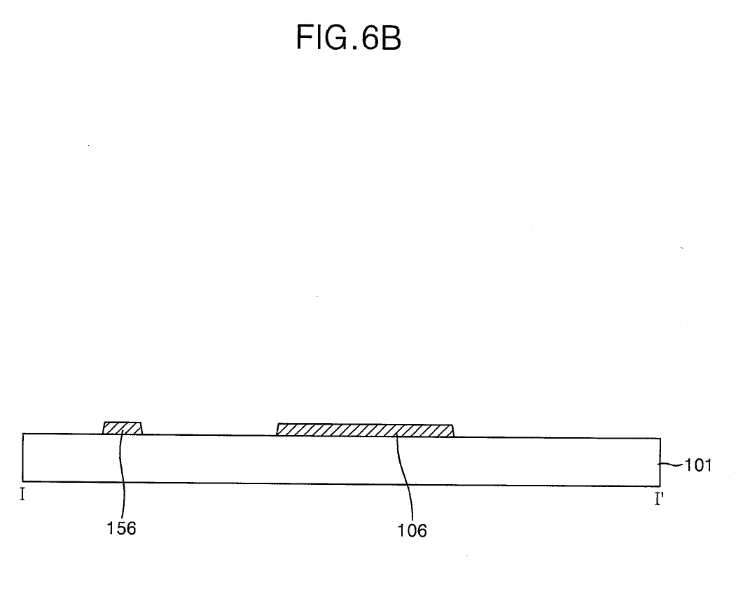

FIG. 6A is a plan view illustrating an exemplary method of forming a gate metal pattern of a sub-pixel of FIG. 1 and FIG. 2, and FIG. 6B is a cross sectional view taken along the line I-I′ of FIG. 6A.

Referring to FIGS. 6A and 6B, a gate metal pattern including a gate line 102, a first gate electrode 156, and a second gate electrode 106 is formed on a dielectric substrate 101. The gate metal pattern is formed by depositing a gate metal layer using a sputtering process and then by patterning the gate metal layer using photolithography and etching processes.

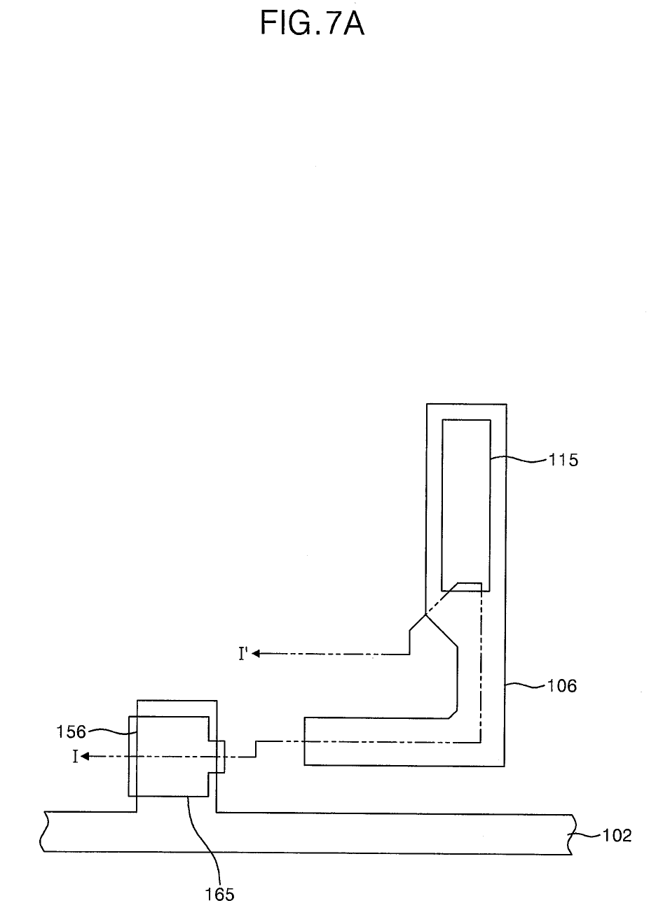

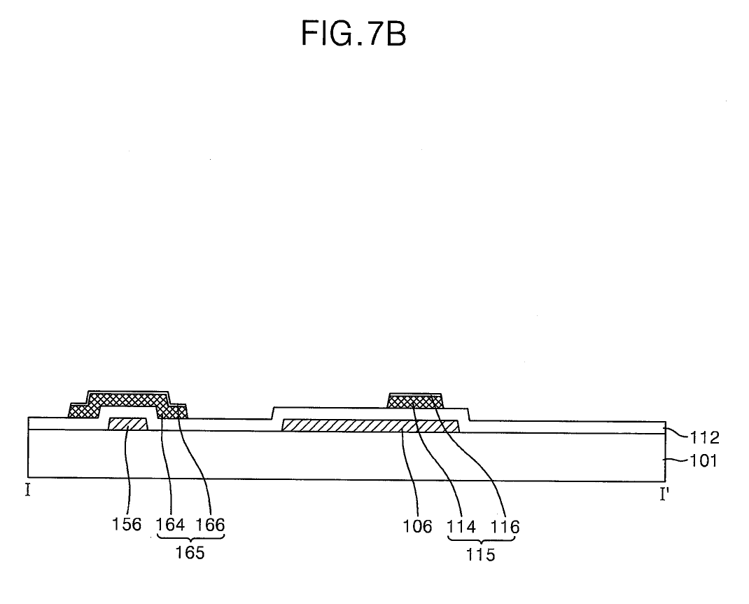

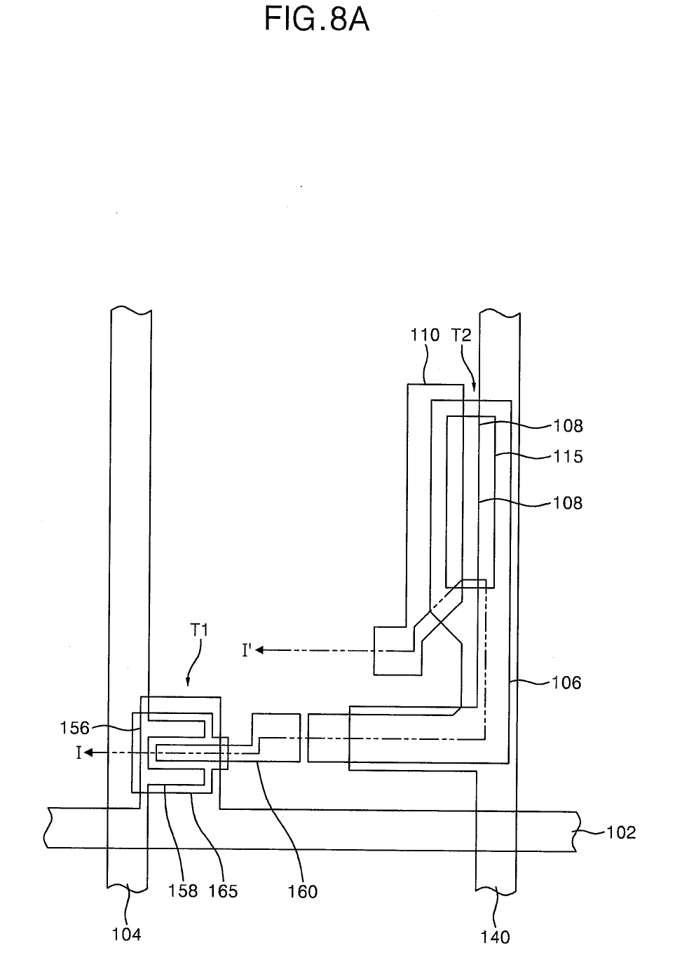

FIG. 7A is a plan view illustrating an exemplary method of forming a semiconductor pattern of the sub-pixel of FIG. 1 and FIG. 2, and FIG. 7B is a cross sectional view taken along the line I-I′ of FIG. 7A.

Referring to FIGS. 7A and 7B, a semiconductor pattern including first and second semiconductor patterns 165 and 115 is formed on the dielectric substrate 101 on which the gate metal pattern is formed. The first semiconductor region 165 consists of a gate dielectric layer 112, a first active layer 164, and a first ohmic contact layer 166; and the second semiconductor pattern 115 consists of the gate dielectric layer 112, a second active layer 114, and a second ohmic contact layer 116.

The gate dielectric layer 112 is formed by depositing an inorganic dielectric material such as a silicon oxide (SiOx) and a silicon nitride (SiNx) on the dielectric substrate 101 having the gate metal pattern, for example by using plasma enhanced chemical vapor deposition (PECVD). The first and second semiconductor patterns 165 and 115 are formed by depositing an amorphous silicon layer and an n+ amorphous silicon layer on the gate dielectric layer 112 and then by patterning the amorphous silicon layers using photolithography and several etching processes.

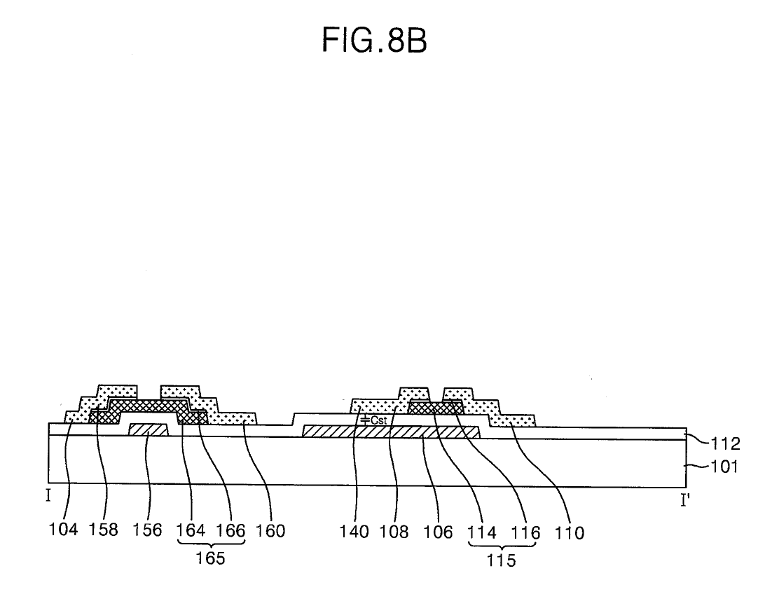

FIG. 8A is a plan view illustrating an exemplary method of forming a source/drain metal pattern of the sub-pixel of FIGS. 1 and 2, and FIG. 8B is a cross sectional view taken along the line I-I′ of FIG. 8A.

Referring to FIGS. 8A and 8B, a source/drain metal pattern includes a data line 104, first and second source electrodes 158 and 108, and first and second drain electrodes 160 and 110.

The source/drain metal pattern is formed by depositing a source/drain metal layer on the dielectric substrate 101 after the first and second semiconductor regions 165 and 115 are formed, using a sputtering process and then by patterning the source/drain metal layer using photolithography and etching processes. After forming the source/drain metal pattern, the first and second ohmic contact layers 166 and 116 between the source/drain pattern are removed using the source/drain pattern as a mask so that the first and second active layers 164 and 114 are exposed between the first source and drain electrodes 158 and 160 and between the second source and drain electrodes 108 and 110.

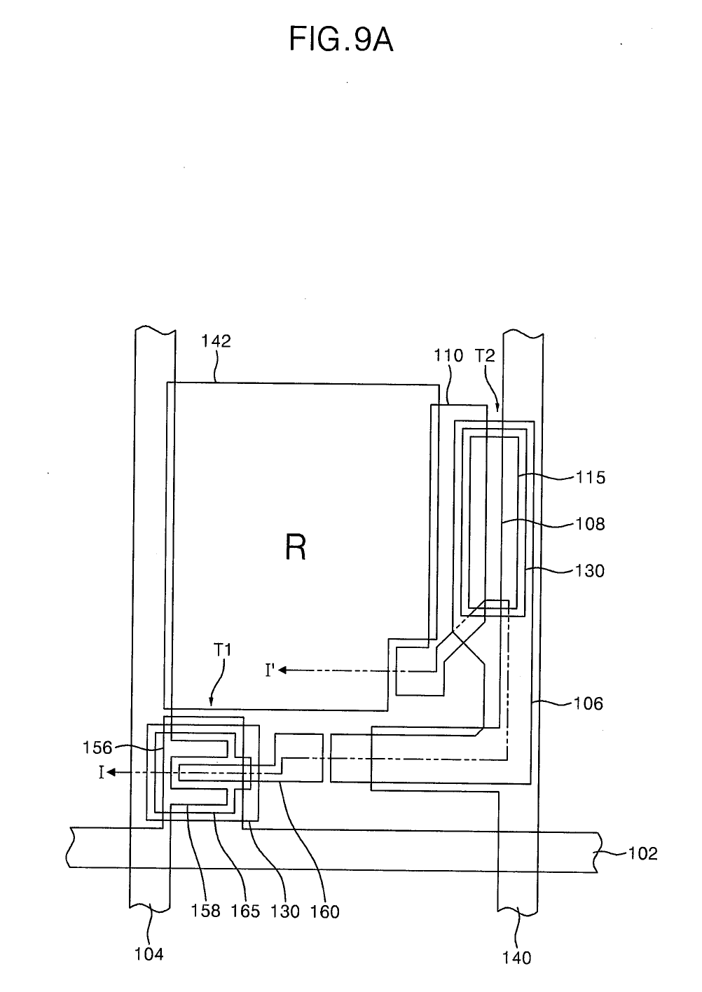

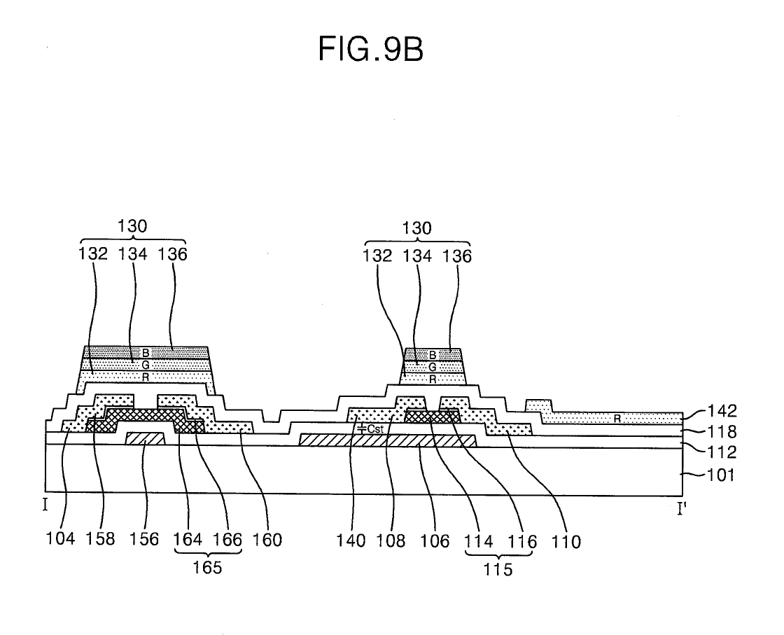

FIG. 9A is a plan view illustrating an exemplary method of forming a light absorption layer of a sub-pixel of FIGS. 1 and 2, and FIG. 9B is a cross sectional view taken along the line I-I′ of FIG. 9A.

Referring to FIGS. 9A and 9B, a protection layer 118 is deposited on the dielectric substrate 101 after the source/drain pattern is formed and then the light absorption layer 130 and the color filter 142 are formed on the protection layer 118. The light absorption layer 130 is formed by depositing red (R), green (G), and blue (B) color layers as first, second, and third color layers 132, 134, and 136.

The protection layer 118 is formed by depositing an inorganic dielectric material such as SiOx and SiNx or an organic dielectric material such as an acrylic resin on the dielectric layer 101 having the source/drain metal pattern.

After forming the protection layer 118, a red color filter 142 and the red color layer as the first color layer 132 are formed by depositing a red pigment material on the protection layer 118 and then by patterning the red pigment material using a photolithography process. A green color filter (not shown) and the green color layer as the second color layer 134 are formed by depositing a green pigment material on the protection layer 118 having the red color filter 142 and the first color layer 132 and then by patterning the green pigment material using a photolithography process. Next, a blue color filter (not shown) and the blue color layer as the third color layer 136 are formed by depositing a blue pigment material on the protection layer 118 having the green color filter and the second color layer 134 and then by patterning the blue color pigment material using a photolithography process.

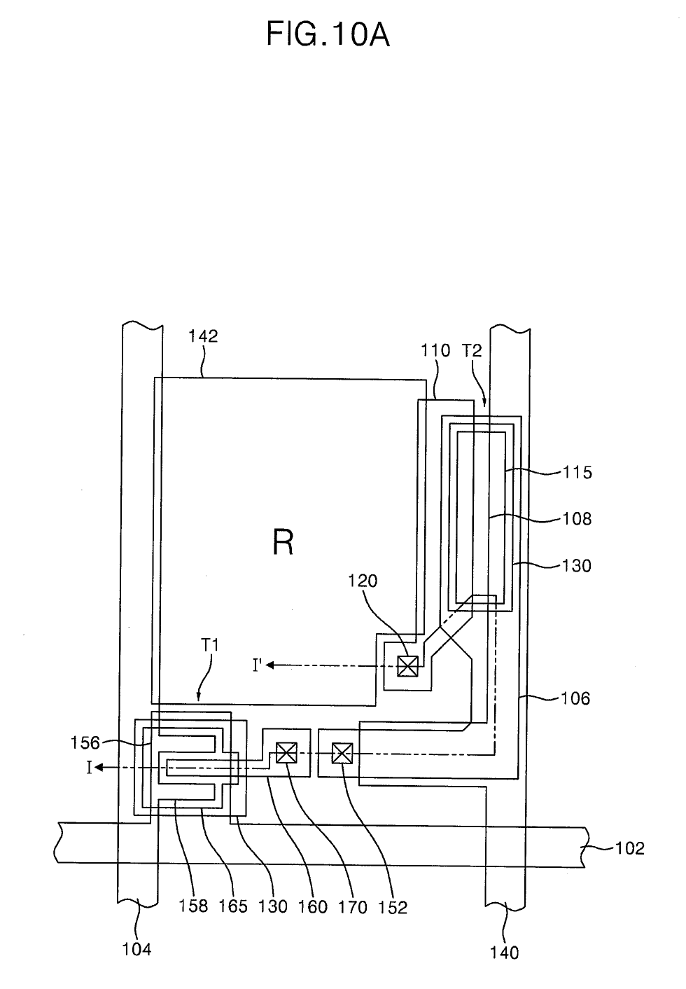

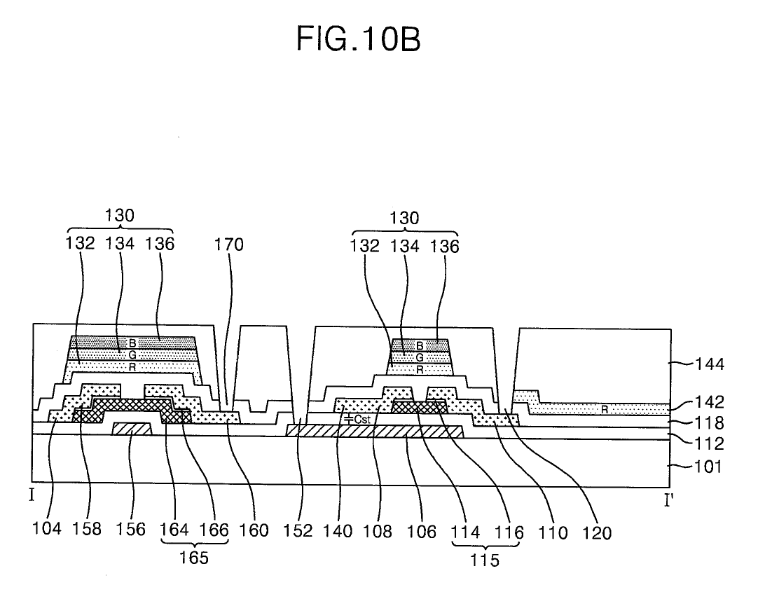

FIG. 10A is a plan view illustrating an exemplary method of forming the planarization layer for the sub-pixel of FIGS. 1 and 2, and FIG. 10B is a cross sectional view taken along the line I-I′ of FIG. 10A.

Referring to FIGS. 10A and 10B, a planarization layer 144 is formed on the dielectric substrate 101 after the color filter 142 for three colors and the light absorption layer 130 are formed. The planarization layer 144 is provided with first to third contact holes 170, 152, and 120.

The planarization layer 144 is deposited by a spin coating process or a spinless coating process. The first, second, and third contact holes 170, 152, and 120 are formed by selectively patterning at least two layers of the gate dielectric layer 112, the protection layer 118, and the planarization layer 144 using photolithography and etching processes. The first contact hole 170 is formed to extend to the first drain electrode 160 of the switching thin film transistor T1 by penetrating the protection layer 118 and the planarization layer 144. The second contact hole 152 is formed to extend to the second gate electrode 106 of the driving thin film transistor T2 by penetrating the gate dielectric layer 112, the protection layer 118, and the planarization layer 144. The third contact hole 120 is formed to extend to the second drain electrode 110 of the driving thin film transistor T2 by penetrating the protection layer 118 and the planarization layer 144.

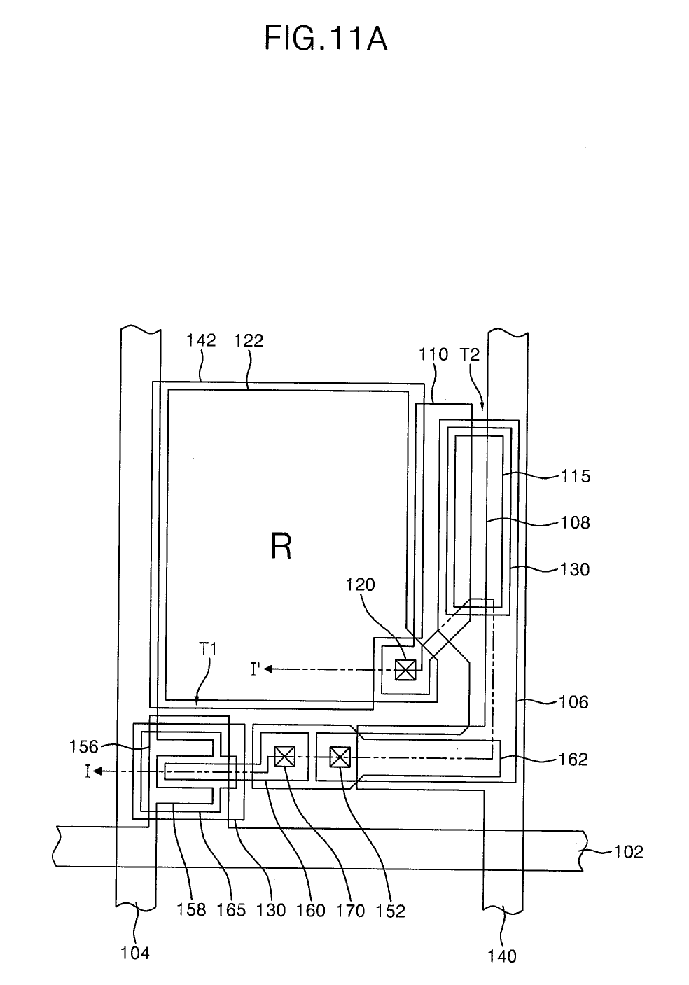

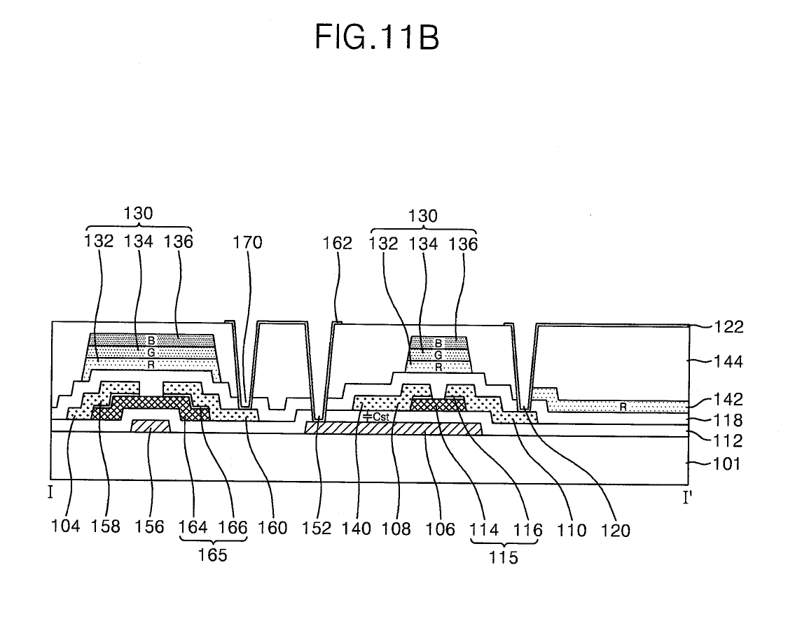

FIG. 11A is a plan view illustrating an exemplary method of forming the transparent conductive pattern for the sub-pixel of FIGS. 1 and 2, and FIG. 11B is a cross sectional view taken along the line I-I′ of FIG. 11A. The transparent conductive pattern includes a connection electrode 162 and an anode 122.

Referring to FIGS. 11A and 11B, the transparent conductive pattern is formed by depositing a transparent conductive layer on the planarization layer 144 using a deposition technique such as sputtering and then by patterning the transparent conductive layer through photolithography and etching processes. The transparent conductive layer may be formed of indium tin oxide (ITO), tin oxide (TO), indium zinc oxide (IZO), indium tin zinc oxide (ITZO), etc.

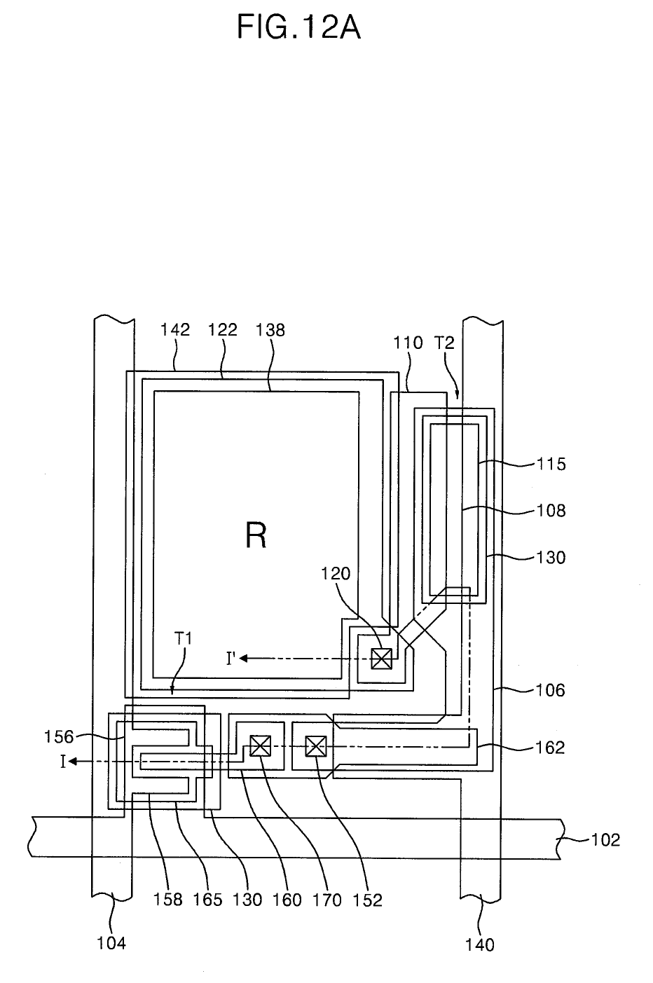

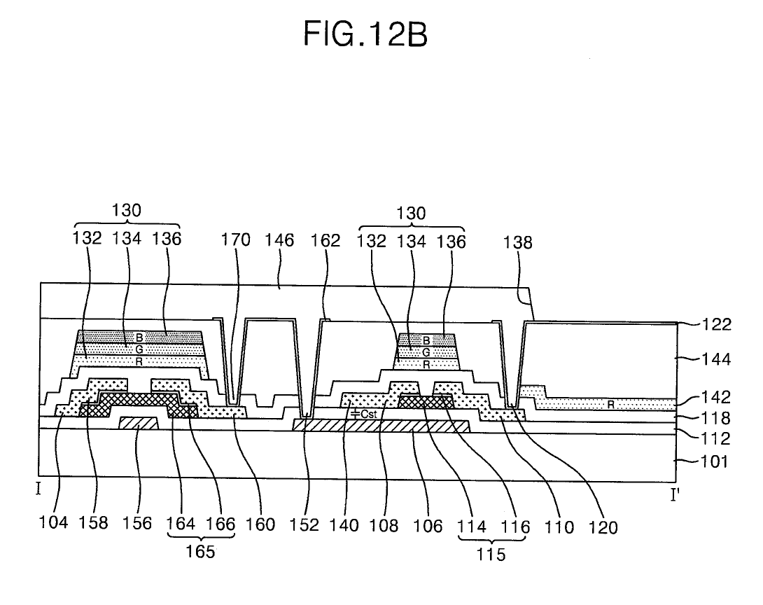

FIG. 12A is a plan view illustrating an exemplary method of forming a pixel hole of a sub-pixel of FIGS. 1 and 2, and FIG. 12B is a cross sectional view taken along the line I-I′ of FIG. 12A.

Referring to FIGS. 12A and 12B, a bank dielectric layer 146, and a pixel hole 138 formed by penetrating the bank dielectric layer 146 are formed.

The bank dielectric layer 146 is formed by depositing an organic dielectric material on the planarization layer 144 having the transparent conductive pattern.

The pixel hole 138 is formed by patterning the bank dielectric layer 146 using a photolithography process and an etching process and extends the anode 122. If the bank dielectric layer 146 is made of a photosensitive organic dielectric material, the pixel hole 138 may be formed by using only a photolithography process.

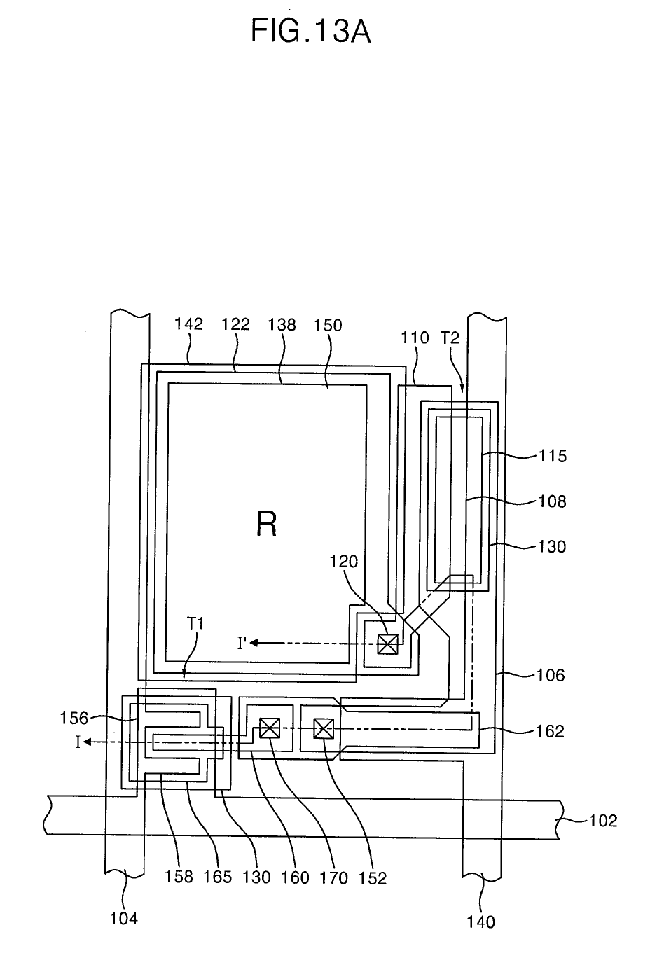

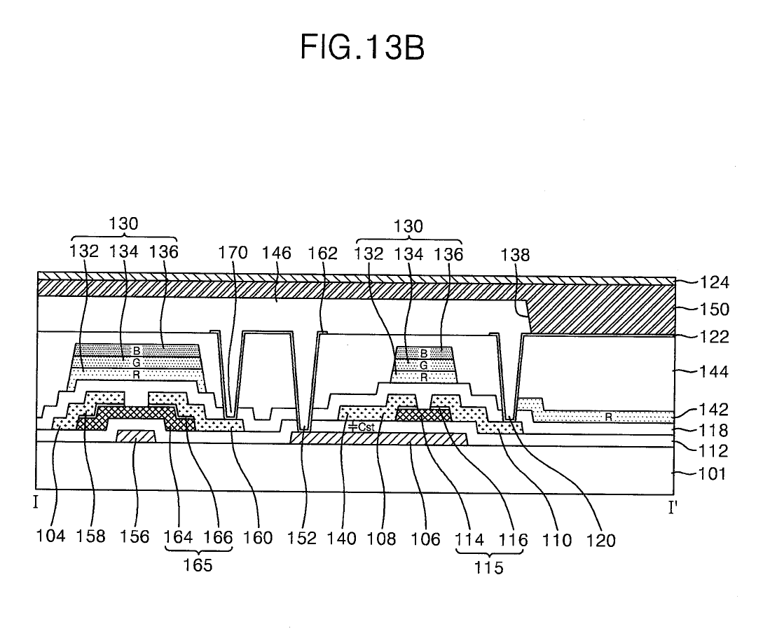

FIG. 13A is a plan view illustrating an exemplary method of forming the organic layer and the cathode for the sub-pixel of FIGS. 1 and 2, and FIG. 13B is a cross sectional view taken along the line I-I′ of FIG. 13B.

Referring to FIG. 13A, an organic layer 150 is deposited on the bank dielectric layer 146 using a screen mask within the pixel hole 138. The organic layer 150 may be implemented with sequentially deposited red, green, and blue color emission layers or two emission layers of complementary colors. Also, the organic layer 150 may be implemented as a single color layer emitting white light.

After forming the organic layer 150, a cathode 124 is formed by depositing a conductive material on the organic layer 150. The cathode 124 may be made of a high-reflectivity material such as Al, Mg, Ag, Ca, or MgAg.

A sealing cap is formed on the cathode 124 to protect the organic layer 150 from oxygen or moisture. The sealing cap may be formed by a glass cap and/or a thin film cap made by alternately depositing organic and inorganic films.

As described above, the OEL display device is provided with a light absorption layer including at least one color layer formed to cover at least one of the channel regions of a switching thin film transistor and a driving thin film transistor. The light absorption layer weakens or absorbs white light that is generated at an organic layer or reflected by a cathode to propagate toward the switching thin film transistor and the driving thin film transistor. As a result, the channel regions of the switching thin film transistor and the driving thin film transistor are prevented from being improperly activated.

While this invention has been described in connection with what is presently considered to be practical exemplary embodiments, it is to be understood that the invention is not limited to the disclosed embodiments and is intended to cover various modifications and equivalent arrangements included within the spirit and scope of the appended claims.

What is claimed is:

1. An organic electro-luminescent display device comprising:
a gate line;
a data line extending substantially perpendicularly to the gate line;
a power supply line supplying a power signal;
a switching thin film transistor connected to the gate line and to the data line, the switching thin film transistor having a first channel region;
a driving thin film transistor connected to the switching thin film transistor and to the power supply line, the driving thin film transistor having a second channel region;
an organic electro-luminescent cell connected to the driving thin film transistor; and
a light absorption layer on at least one of the first and second channel regions, the light absorption layer being formed of at least one color layer.

2. The organic electro-luminescence display device of claim 1, wherein the organic electro-luminescent cell comprises:
an anode connected to the driving thin film transistor;
an organic layer formed on the anode; and
a cathode formed on the organic layer.

3. The organic electro-luminescence display device of claim 2, wherein the organic layer includes a light emission layer generating white light.

4. The organic electro-luminescence display device of claim 3, further comprising a red color filter, a green color filter, and a blue color filter formed in sub-pixel regions and overlapping the anode.

5. The organic electro-luminescence display device of claim 4, wherein the light absorption layer is formed from the substantially same material as at least one of the red, green, and blue color filters.

6. The organic electro-luminescence display device of claim 1, wherein the light absorption layer comprises a plurality of color layers emitting different colors.

7. A method of manufacturing an organic electro-luminescent display device, the method comprising:
forming a switching thin film transistor connected to a gate line and to a data line on a dielectric substrate, the switching thin film transistor having a first channel region;
forming a driving thin film transistor connected to the switching thin film transistor and to a power supply line on the dielectric substrate, the driving thin film transistor having a second channel region;
forming a light absorption layer formed of at least one color layer on least one of the first and the second channel regions; and
forming an organic electro-luminescent cell connected to the driving thin film transistor.

8. The method of claim 7, wherein forming an organic electro-luminescent cell comprises:
forming an anode connected to the driving thin film transistor;
forming an organic layer on the anode, wherein the organic layer is capable of generating white light; and
forming a cathode on the organic layer.

9. The method of claim 8, further comprising forming a red color filter, a green color filter, and a blue color filter overlapping the anode in the sub-pixel regions using the same mask process as for forming the light absorption layer.

10. The method of claim 9, wherein forming the light absorption layer comprises forming at least one color layer formed from the substantially same material as at least one of the red, green, and blue color filters.

11. The method of claim 7, wherein the light absorption layer comprises a plurality of color layers emitting different colors.
